(19) United States
(12) Patent Application Publication
(10) Pub. No.: US 2004/0111421 A1
(43) Pub. Date: Jun. 10, 2004

(54) Data source synthesis

(76) Inventors: Norman H. Cohen, Suffern, NY (US); Apratim Purakayastha, Yorktown Heights, NY (US)

Correspondence Address: THE LAW OFFICE OF IDO TUCHMAN, 69-60 108ST., SUITE 503, FOREST HILLS, NY, 11375, US

(21) Appl. No.: 10/315,758

(22) Filed: Dec. 10, 2002

(51) Int. Cl. G06F 7/00

(52) U.S. Cl. 707/100

(57) ABSTRACT

A method, system, and computer program providing data of a requested kind includes a repository of descriptors for external data sources and a repository of templates for synthesizers that, given inputs satisfying stated requirements, can act as data sources satisfying a stated requirement. A set of data sources satisfying a stated requirement is constructed by selecting appropriate external data sources from the repository of data-source descriptors, discovering appropriate synthesizer templates in the repository of synthesizer templates, and synthesizing data sources by instantiating templates to use other external or synthesized data sources as inputs, in accordance with the requirements associated with the inputs and outputs of the templates.

### FIELD OF THE INVENTION

The present invention generally relates to systems providing data of a requested kind, and more particularly to the automated synthesis of suitable data from other kinds of data.

### BACKGROUND

U.S. Pat. No. 5,761,499 titled “Method for managing globally distributed software components,” and U.S. Pat. No. 5,928,323 titled “Apparatus and method for dynamically generating information with server-side software objects,” are among the many approaches for implementing a service by selecting a particular executable entity from a server-based repository upon receipt of a request from a client, and executing that entity on the server. The repertoire of services available using such approaches is generally limited to those that have been placed in the server-based repository.

U.S. Pat. No. 6,256,771 titled “Method and apparatus for providing a dynamic service composition software architecture,” allows a service to be constructed dynamically just before the service is invoked, from “component netlets” selected from a repository. “Service netlets,” also stored in the repository, are each capable of configuring a particular service out of component netlets. A service netlet is invoked when an “agent adapter,” in response to an input from a user-access device such as a phone, personal digital assistant, or Internet browser, selects a service netlet from the repository and invokes it. Component netlets communicate with each other through the transmission of “events”; a service netlet configures a service by selecting component netlets from the repository and determining which component netlets will transmit events to which. The construction of network services out of components with constrained interfaces provides flexibility in assembling novel services, and the dynamic configuration of the service at service-invocation time rather than at service design time allows component netlets to be invoked at particular nodes of a distributed network in response to the currently measured performance of each node. However, the repertoire of available services is fixed, based on the repertoire of service netlets available in the repository. Each service netlet embodies a hard-coded method for configuring its service from the repertoire of component netlets in the repository.

U.S. patent application Ser. No. 20020023088A1 titled “Information routing,” describes hierarchies of “blocks” that can act as information-providing elements, information-processing elements, or both. However, these hierarchies are based on “exchange sets” that are registered with an “information routing layer” and identify statically the fields consumed and produced by each block. The information routing layer uses exchange sets to route information among blocks. The possible hierarchies are highly constrained by the static definition of fields.

U.S. Pat. No. 5,522,073 titled “Method and apparatus for automating and controlling execution of software tools and tool sets via when/then relationships,” describes a system that allows an end-user to compose “tool routines” out of tools that generate, and are triggered by, events. All compositions must be designed by end users. Similarly, U.S. Pat. No. 6,330,710 titled, “Servlet-based architecture for dynamic service composition,” describes the use of servlets at server computers to receive instructions from client computers on how to configure existing components to form a network service. However, the clients are responsible for specifying the components to be configured.

The Ninja Automatic Path Creator (http://www.cs.berkeley.edu/˜madden/paths/) automates the construction of a “path” of “intermediate operators” leading from a “source operator” to a “destination operator.” All operators are Java programs. The source operator and all intermediate operators have output streams, and XML specifications of the structure and meaning of the output; the destination operator and all intermediate operators have input streams, and XML specifications of the structure and meaning of the input. A path is constructed by selecting a sequence of operators, beginning with the source operator and ending with the destination operator, such that the XML specifications for the output of one operator match the XML specifications for the input of the next operator. The XML specifications can describe attributes of particular kinds of data, such as text, image, speech audio, and video. Service composition is limited to stringing a sequence of operators, each with one input stream and one output stream, in series. The algorithm for discovering composition opportunities is a fixed algorithm for matching operator input and output types according to fixed criteria.

Thus there are many existing approaches to synthesizing a source for one kind of data out of sources for other kinds of data. However, with the exception of the Ninja Automatic Path Creator, they rely on a fixed repertoire of combining approaches, devised by humans. The Ninja Automatic Path Creator automatically discovers a sequence of operators that, applied in succession, transform an available kind of data into the desired kind of data. However, this approach is generally limited to a single source of input data and transformations that each have one input source and one output source.

### SUMMARY OF THE INVENTION

In view of the foregoing deficiencies of the existing approaches, it is an object of the present invention to synthesize sources for a requested kind of data automatically from a set of one or more external data sources and a fixed set of synthesizers. A synthesizer takes one or more sources of input and produces output. The input to a synthesizer may be one of the original external data sources, or it may be the result of another synthesizer. Thus it is possible to construct a hierarchy of synthesizers that combine the data from external data sources to generate the requested kind of data.

Data sources, including both the original external data sources and synthesizers, have contracts promising that their outputs have certain characteristics. Data sources may be active, passive, or hybrid. An active data source takes the initiative in emitting values. A passive data source provides data in response to an explicit request. A hybrid data source does both. Synthesis entails not merely the creation of data, but the creation of data sources, whose contracts may stipulate certain quality-of-information or quality-of-service characteristics. An example of a quality-of-information characteristic is that a data source for a car's fuel level not report readings that deviate more than 10% from the average reading over the past minute. An example of a quality-of-service characteristic is that an active data source generate a new value at least four times a minute.

One embodiment of the present invention incorporates a repository of descriptors for external data sources and a repository of synthesizer templates. In one embodiment, the repository of data-source descriptors could be a data-source discovery system such as the iQueue data resolver described in Norman H. Cohen, Apratim Purakayastha, Luke Wong, and Danny L. Yeh, “iQueue: a pervasive data-composition framework,” 3rd International Conference on Data Management, Singapore, Jan. 8-11, 2002, 146-153, and incorporated herein by reference. This system receives advertisements from data sources, or from agents associated with data sources, and yields descriptors for data sources whose advertisements indicate that the sources satisfy specified requirements. However, the present invention can be applied to a wide variety of data-source-descriptor repositories.

A synthesizer template specifies a method for synthesizing a data source meeting a given set of requirements, given data sources that meet other requirements, specified as part of the template. In one embodiment, synthesizer templates could take the form of iQueue composers described in the aforementioned paper by Cohen et al., and the iQueue composer manager described in that paper could serve as a repository for synthesizer templates. However, the present invention can be applied to a wide variety of synthesizer templates and synthesizer-template repositories.

Data-source synthesis methods that could be expressed by synthesizer templates include value-based methods that repeatedly take a single value from each of one or more input sources and yield a single corresponding output value, and stream-based methods that generate sequences of output values from one or more input sources, without a direct correspondence between input values and output values. Value-based methods include, but are not limited to, the following kinds of methods:

Translation. A synthesizer with a single source of input yields, for each value obtained from that source, an equivalent value expressed according to a different convention. One example of translation is reformatting, say from a date of the form “15 May 1985” to one of the form “1985-05-15”. Another form of translation is physical-unit conversion, for example multiplying a temperature in degrees Celsius by 1.8 and adding 32 to obtain a temperature in degrees Fahrenheit.

Projection. Given an input source for a kind of data that includes multiple parts, individual parts can be extracted from each data value to obtain data of a kind that includes a subset of those parts. For example, given a stock-transaction report consisting of a stock's price and the number of shares traded, a report can be generated consisting only of the stock's price.

Lookup. Data obtained from an input source can be used as an index to locate corresponding data of another kind. The corresponding data might be obtained from a database, from a special-purpose file, from a web service, or from some other source. For example, zip codes could be used as indexes to look up corresponding city names.

Combination. A formula can be applied to compute one kind of data from two or more other kinds of data. For example, wind-chill-factor data can be obtained by combining wind-speed data and temperature data.

Stream-based methods include, but are not limited to, the following kinds of methods:

Activation. A passive data source can be polled at regular intervals, and the values obtained can be actively emitted, to synthesize an active data source from a passive one. For example, a passive stock-quote service can be polled at one-minute intervals to obtain an active data source that emits the current price of a specified stock every minute.

Aggregation over time. Upon the receipt of a new value from an input source, an output value can be emitted that is computed from all the input values received so far, or from the last n values received for some value of n, or from all input values received in the last t seconds for some value of t. For example, upon the receipt of a new value from an input source, the average of the ten most recent values can be emitted, to synthesize a source for a smoothed sequence of values from a source for a raw sequence of values.

Compound-event recognition. Patterns of arriving values can be recognized as constituting compound events, and a corresponding value can be emitted each time a compound event is recognized. For example, if two cars are detected entering the queue for a drive-up window and the second car is detected reaching the front of the queue without the first car having been detected reaching the front of the queue earlier, a compound event corresponding to the first car leaving the queue can be emitted.

Filtering. Input values satisfying certain criteria can be emitted as output values, while input values not satisfying those criteria are ignored. For example, a stream of boiler-pressure readings can be filtered to include only those readings outside of the safe operating range, producing a data source for reports of unsafe-pressure alerts.

Merging. Input streams can be merged into a single output stream by emitting any value received from any of two or more active input sources. For example, a stream of reports of ID numbers of employees entering a building through the front entrance can be merged with a stream of reports of ID numbers of employees entering the building through the back entrance to obtain a stream of reports of ID numbers of all employees entering the building.

These lists are illustrative. It will be clear that the present invention is capable of accommodating synthesis methods in addition to those listed.

Given a set of requirements for a data source, one embodiment of the invention constructs sets of suitable data sources through a recursive subgoal-driven search. Every element of the set is a data source, either taken from the repository of descriptors for external data sources or synthesized, that satisfies the requirements. It is also possible to obtain a single data source, selected from this set according to some criterion. Examples of criteria for selecting one data source from a set of suitable data sources include, for example, cost metrics and performance metrics.

The recursive subgoal-driven search proceeds as follows: First, the set S of suitable data sources is initialized to the set of external data sources found in the repository of data-source descriptors that directly satisfy the requirements. (Often this set will be empty.) Next, each template in the synthesizer-template repository whose output satisfies the requirements is examined. For each of the template's input sources, the recursive subgoal-driven search finds a set of data sources that meet that template's requirement for that input source. For each n-tuple consisting of one data source from each template input source's set (where n is the number of data inputs that the template has), a synthesizer is created as an instance of the synthesizer template, using the data sources of the n-tuple for its inputs, and the synthesizer is added to the result set S.

The present invention anticipates variations on the recursive subgoal-driven search that result from well-known program transformation techniques. For example, the recursive subgoal-driven search can be transformed, by techniques well known to those familiar in the art, to a nonrecursive search. Similarly, the search can be transformed, by techniques such as those found in R. S. Bird, “Tabulation techniques for recursive programs,” ACM Computing Surveys 12, No. 4 (December 1980), 403-417, and in Norman H. Cohen, “Eliminating redundant recursive calls,” ACM Transactions on Programming Languages and Systems 5, No. 3 (July 1983), pp. 265-299, into one that avoids redundant computation of result sets.

The present invention also anticipates variations that shorten the recursive subgoal-driven search by omitting parts of it. For example, one variation is to terminate the search and return a single data source as soon as a suitable data source is found; another variation is to use techniques analogous to alpha-beta pruning (described, inter alia, in section 5-12 of Nils J. Nilsson, Problem Solving Methods in Artificial Intelligence, McGraw-Hill Book Company, New York, 1971) to elide parts of the search that can be determined beforehand to yield only data sources less preferable, or equally preferable, to some data source that has already been found.

The properties one would wish to specify for a data source vary depending on the nature of the data source. For a data source providing the temperature in a location of interest, it is necessary to specify the location. For a data source providing the current position of a given cell phone, it is necessary to specify some unique identifier for the cell phone. Thus definition of a universal language for data-source specification is not feasible.

Nonetheless, a uniform framework for specification of data-source properties is achievable. One approach is based on XML standards: Some organization, such as a consortium or standards body, or the provider of a data source, would define an XML schema for describing properties of that kind of data source. Each such schema would be derived from a common XML schema for data-source descriptors. A specification of required data-source properties could then be written as an XQuery over data-source descriptors conforming to the schema for that kind of data source. Multiple schemas might arise for some similar kinds of data sources, but eventually market forces or social processes would cause one of these schemas to predominate. Other approaches to specification of data-source properties are also possible.

Thus, the present invention includes a method, system and computer program for obtaining data sources satisfying a result requirement in a network environment that includes external data sources and synthesizer templates. Each external data source has an output contract and each synthesizer template corresponds to a synthesis method capable of producing an output value from input values, synthesizer-input requirements to be satisfied by inputs, and a synthesizer-output contract satisfied by each resulting output. A first selecting operation selects a synthesizer template to be instantiated. A second selecting operation selects, for each input of the synthesizer template, an external or synthesized data source whose output contract satisfies the synthesizer-input requirement for the input of the synthesizer template. An instantiating operation instantiates the synthesizer template using the data sources selected for the synthesizer-template inputs, thereby obtaining a new synthesized data source that may be selected in subsequent performances of the second selecting operation. A constructing operation constructs a set consisting of at least one resulting synthesized data source or external data source whose output contract satisfies the result requirement.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 is a block diagram illustrating an exemplary system that synthesizes data sources automatically.

FIG. 2 depicts an exemplary hierarchy of synthesized and external data sources.

FIGS. 3A-3C are an exemplary flowchart depicting the process by which the current invention synthesizes data sources satisfying a given set of requirements.

FIG. 4 shows an exemplary stack of recursive invocations of the process depicted in FIGS. 3A-3C, each invocation having its own copy of the local variables used by that process.

FIGS. 5A-5B are an example set of synthesizer templates.

FIG. 6 is an example of a tree of dynamic invocations of the process depicted in FIGS. 3A-3C.

FIGS. 7A-7B depict the data sources that are elements of the sets returned by invocations of the process depicted in FIGS. 3A-3C.

### DETAILED DESCRIPTION OF THE INVENTION

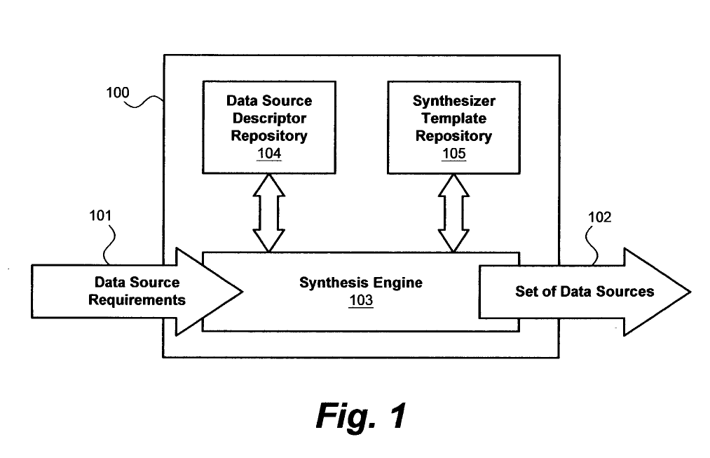

FIG. 1 is a block diagram of a system 100 that receives requirements 101 for data sources and produces sets 102 of data sources satisfying those requirements. These data sources are synthesized by a synthesis engine 103, by using synthesizers to combine external data sources. Descriptors for these external data sources are retrieved from the data-source-descriptor repository 104. The synthesizers are instances of synthesizer templates retrieved from the synthesizer-template repository 105. The data-source-descriptor repository 104 may be a service-discovery mechanism that accepts advertisements of data sources and responds to requests for data sources satisfying specified requirements by yielding descriptors for data sources that have been advertised to it and that satisfy those requirements.

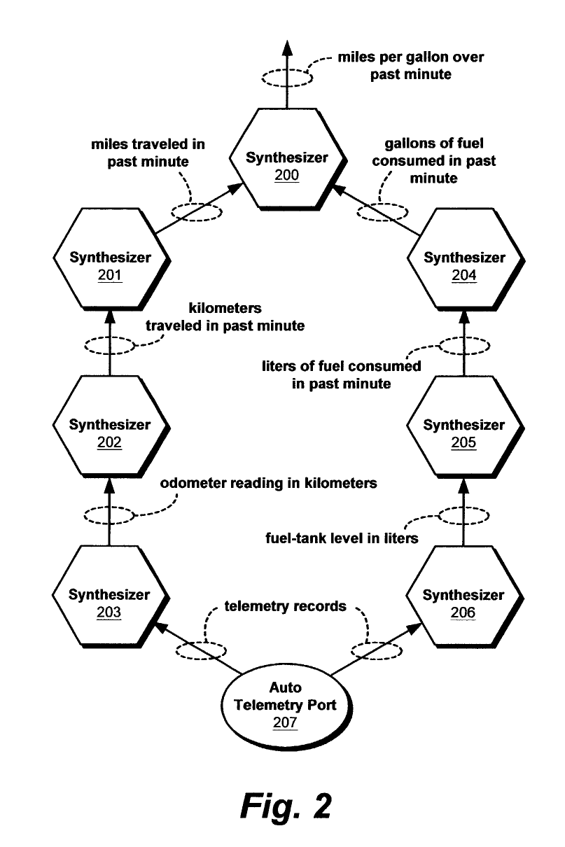

FIG. 2 depicts an example of a synthesized data source reporting the fuel efficiency of an automobile in miles per gallon. Every second, the data source reports the average fuel efficiency over the past 60 seconds. The synthesis makes use of a single external data source, a telemetry port 207 that issues a vector of data about the automobile once every second. The data in the vector includes the automobile's odometer reading in kilometers and the automobile's fuel level in liters. Projection synthesizer 203 extracts the odometer reading from this vector. Time-aggregation synthesizer 202 retains the last 60 odometer readings and, each second, emits the difference between the just-received odometer reading and the reading received one minute earlier. Translation synthesizer 201 converts the distance traveled over the last minute from kilometers to miles. Projection synthesizer 206 extracts the fuel-level reading from the automobile's telemetry vector. Time-aggregation synthesizer 205 retains the last 60 fuel-level readings and, each second, emits the difference between the just-received fuel-level reading and the reading received one minute earlier. Translation synthesizer 204 converts the amount of fuel consumed over the last minute from liters to gallons. Combination synthesizer 200 divides the number of miles traveled over the last minute by the number of gallons of fuel consumed over the last minute to obtain the fuel efficiency over the last minute in miles per gallon.

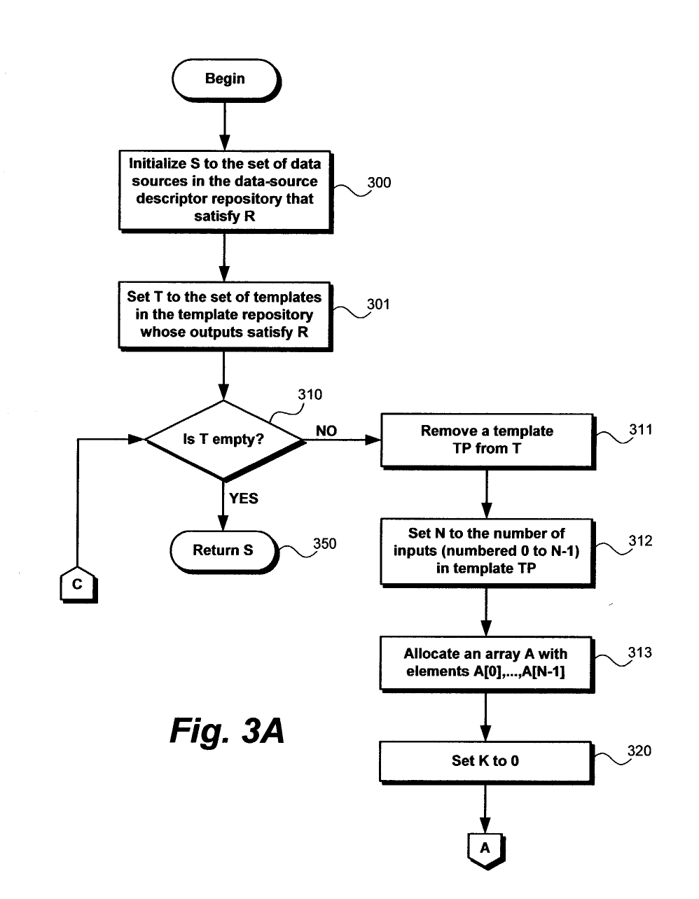

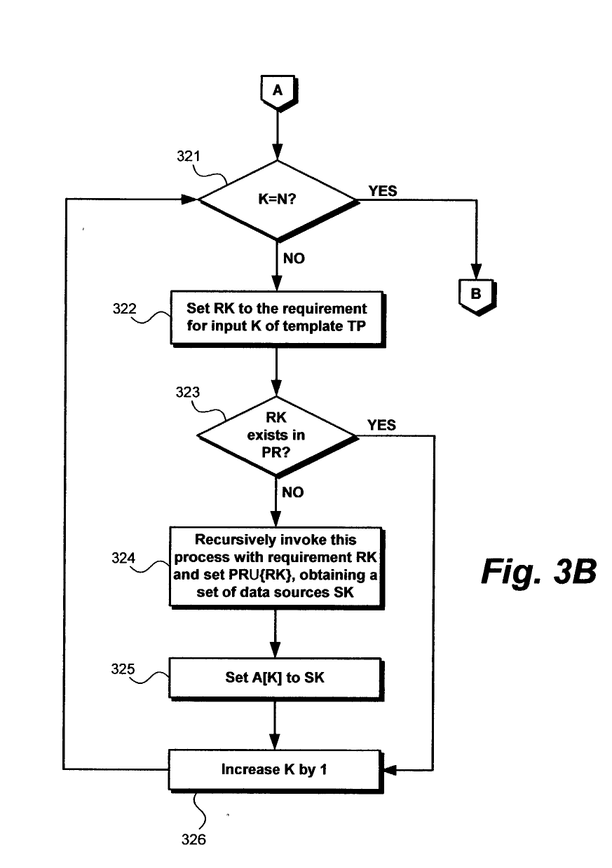

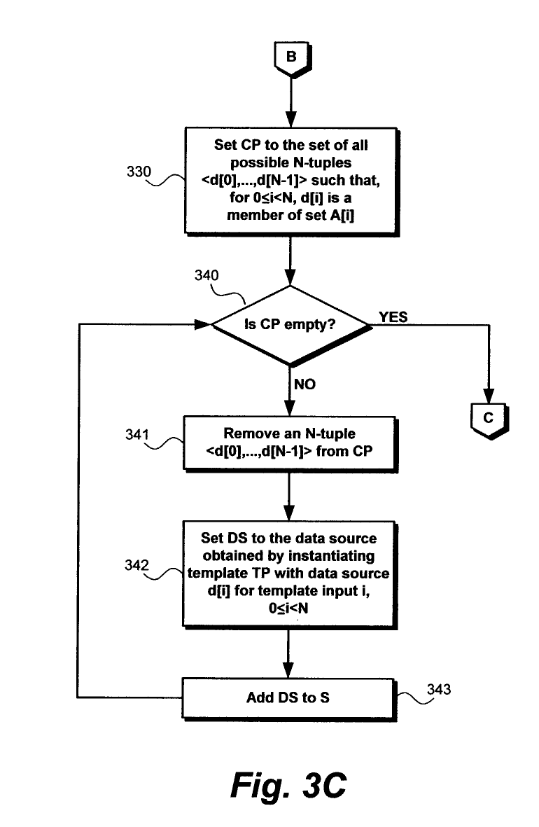

To construct a set of data sources satisfying a specified requirement X, a recursive process is invoked that constructs a set of data sources satisfying specified requirement R in the context of a set PR of pending requirements, using the requirement X for R and using the empty set for PR. FIGS. 3A-3C are a flowchart of the recursive process for constructing a set S of data sources satisfying specified requirement R, in a context of a set PR of pending requirements. The set S includes both external data sources that satisfy R and synthesized data sources that satisfy R. A step 300 initializes a set of data sources S to those external data sources in data-source-descriptor repository 104 that satisfy R. The remainder of the process consists of a step 301 that sets T to the set of templates in synthesizer-template repository 105 that satisfy R, a loop consisting of steps 310, 311, 312, 313, 320, 321, 322, 323, 324, 325, 326, 330, 340, 341, 342, and 343 that is executed once for each element of T, and a step 350 that returns the set of data sources in S after this loop has terminated. The loop repeatedly executes a step 310 that tests whether T is empty, exits the loop if so, and executes the loop body otherwise. The loop body consists of steps 311, 312, and 313, a first inner loop consisting of steps 320, 321, 322, 323, 324, 325, and 326, a step 330, and a second inner loop consisting of steps 340, 341, 342, and 343. Step 311 removes an element from set T and assigns it to TP, step 312 sets N to the number of inputs in template TP, and step 313 allocates an array A with N elements, each initialized to an empty set of data sources. The N inputs of template TP are numbered 0 through N−1, as are the N elements of array A. The first inner loop is executed once for each value in the range 0 through N−1, with a counter variable K taking on each of these values in turn. The first inner loop executes a step 320 initializing K to zero and repeatedly executes a step 321 that tests whether K equals N and exits the first inner loop if so; a loop body consisting of steps 322, 323, 324, and 325; and a step 326 that increments K. Step 322 sets RK to the requirements for input K of template TP and step 323 tests whether RK is already in the set PR of pending requirements. If not, step 324 recursively invokes the process depicted in FIGS. 3A-3C using requirement RK for R and using the set RPU{RK} for RP, and step 325 stores the result of this recursive invocation in array element A[K]; otherwise, A[K] remains empty.

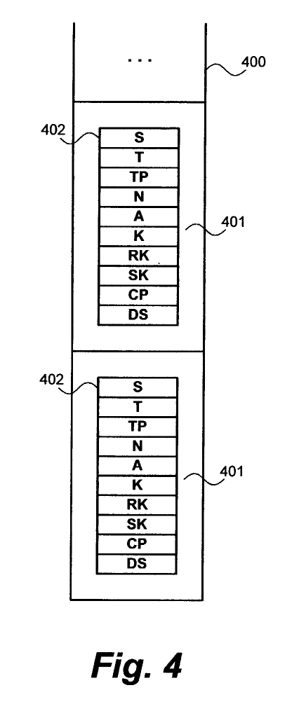

(As shown in FIG. 4, each recursive invocation of the process depicted in FIGS. 3A-3C works with its own copy of the local variables 402 manipulated by the process. Each of these copies is part of an activation record 401 maintained on a stack 400 of activation records. Such a stack is part of most internal implementations of programming languages that support recursion.)

Returning to FIGS. 3A-3C, the step 330 executed following the first inner loop sets CP to the Cartesian product of the sets A[0] through A[N−1]. This Cartesian product is the set of all N-tuples <d₀, . . . , d_{N-1}>(where d₀, . . . , d_{N-1} are data sources) such that d₀εA[0], . . . , d_{N-1}εA[N−1]. If any of the sets A[0] through A[N−1] is empty, the resulting Cartesian product is an empty set. The second inner loop, executed once for each N-tuple in CP, repeatedly executes a step 340 that tests whether CP is empty, exits the loop if so, and executes the second inner loop body otherwise. The second inner loop body consists of a step 341 that removes an N-tuple <d₀, . . . , d_{N-1}>from CP, a step 342 that instantiates the data-source template TP by using data sources d₀, . . . , d_{N-1} for inputs 0, . . . , N−1 of TP, respectively, thus obtaining a data source DS, and a step 343 that adds DS to the set S.

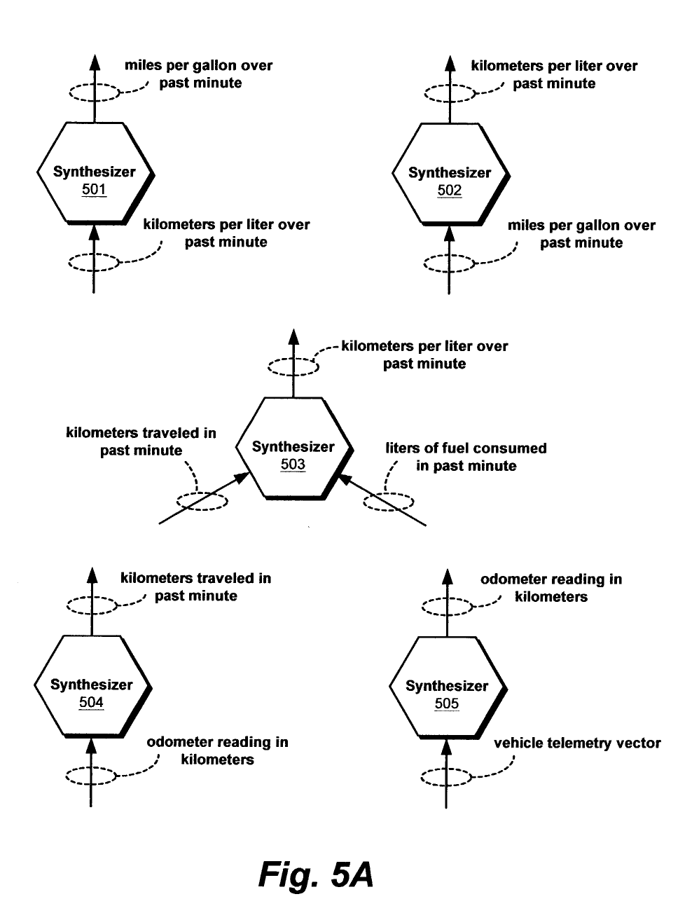

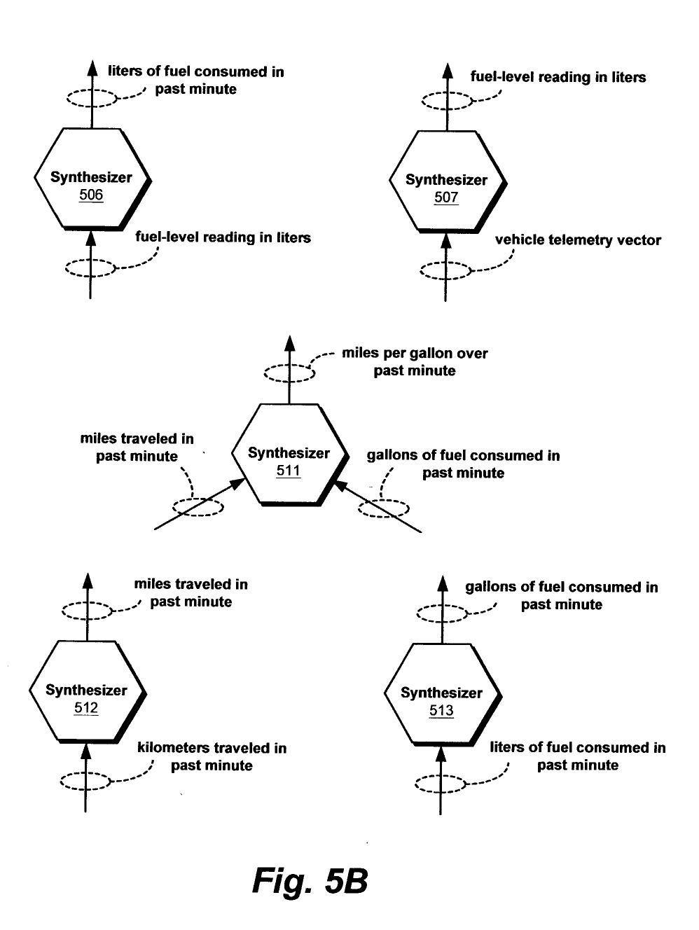

To illustrate the application of this process to construct a set of synthesized data sources that includes the synthesized data source of FIG. 2, consider an example in which the synthesizer-template repository 105 contains the templates illustrated in FIGS. 5A-5B. These include a template 501 for translating fuel efficiency in kilometers per liter over the past minute to fuel efficiency in miles per gallon over the past minute, a template 502 for translating fuel efficiency in miles per gallon over the past minute to fuel efficiency in kilometers per liter over the past minute, a template 503 for computing fuel efficiency in kilometers per liter over the past minute from kilometers traveled over the last minute and liters of fuel consumed over the last minute, a template 504 for aggregating streams of one-per-second odometer readings in kilometers into streams of one-per-second reports of numbers of kilometers traveled over the last minute, a template 505 for extracting a stream of one-per-second odometer readings from one-per-second vehicle telemetry vectors, a template 506 for aggregating streams of one-per-second fuel-level readings in liters into streams of one-per-second reports of liters of fuel consumed over the last minute, a template 507 for extracting a stream of one-per-second fuel-level readings from one-per-second vehicle telemetry vectors, a template 511 for computing fuel efficiency in miles per gallon over the past minute from miles traveled over the last minute and gallons of fuel consumed over the last minute, a template 512 for translating kilometers traveled over the last minute into miles traveled over the last minute, and a template 513 for translating liters of fuel consumed over the last minute into gallons of fuel consumed over the last minute. It is assumed that data-source-descriptor repository 104 contains the descriptor for one external data source—a vehicle telemetry unit providing a vehicle telemetry vector once each second. The requirement X is for a data source that provides, once each second, the fuel efficiency of a given automobile over the last minute, in miles per gallon.

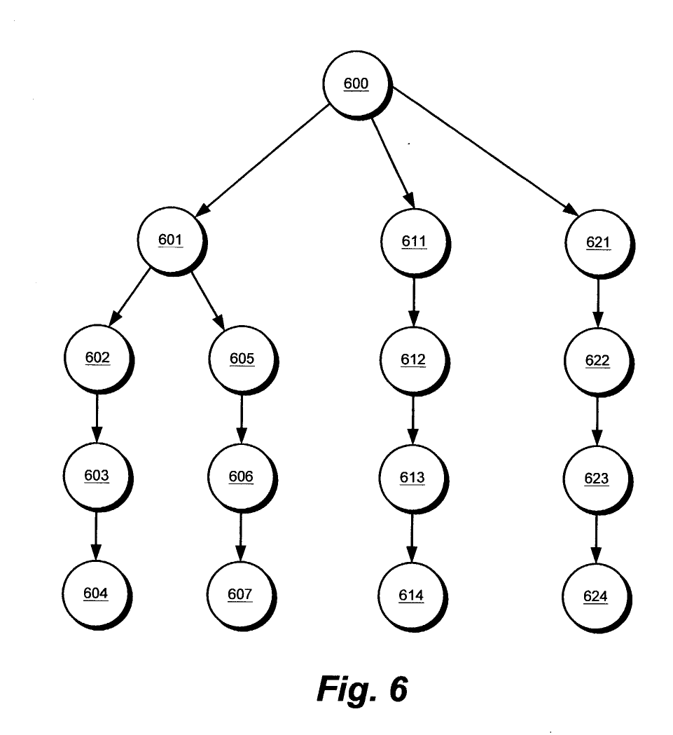

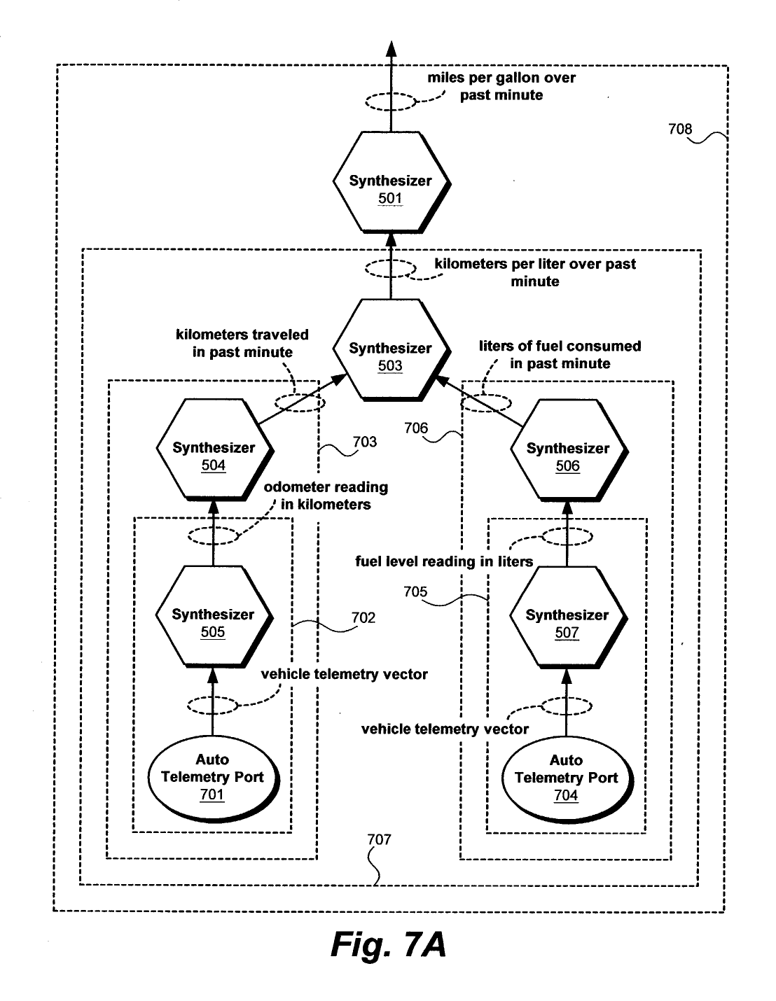

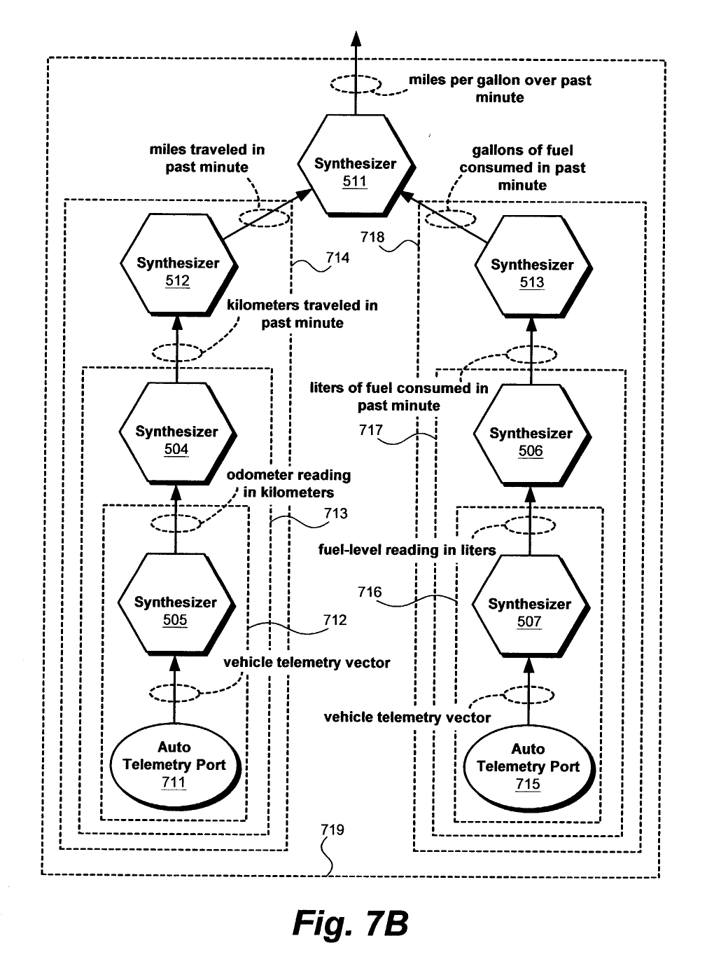

FIG. 6 is a tree of the recursive invocations of the process depicted in FIGS. 3A-3C that arise from this example. Each circle represents an invocation of the process. An arrow from one circle to another means that step 324 of the invocation represented by the first circle activated the invocation represented by the second circle. The data sources in the sets returned by these invocations are depicted in FIGS. 7A-7B. Invocation 600 is the initial invocation, with R set to X (a requirement for once-per-second reports of fuel efficiency over the last minute in miles per gallon) and PR set to the empty set of requirements. Since the data source described in the data-source-descriptor repository does not satisfy R, step 300 of invocation 600 initializes S to the empty set. Step 301 sets T to the set consisting of the synthesizer templates 501 and 511, both of which have outputs (fuel efficiency in miles per gallon over the past minute) that satisfy R. Let us suppose that in the first-iteration of the outer loop, step 311 sets TP to template 501 and removes that template from T. Since template 501 has one input, step 312 sets N to 1 and step 313 sets A to a one-element array. The first inner loop is executed once, with K=0: In step 322, RK is set to the requirement for input 0 of template 501, a requirement for once-per-second reports of fuel efficiency over the last minute in kilometers per liter. Since PR is the empty set, RK is not in PR, so step 324 activates invocation 601, with R equal to a requirement for once-per-second reports of fuel efficiency over the last minute in kilometers per liter and PR equal to the set containing one requirement, for once-per-second reports of fuel efficiency over the last minute in miles per gallon.

Step 300 of invocation 601 sets the copy of S for invocation 601 to the empty set and step 301 sets the copy of T to the set consisting of templates 502 and 503 (both of which produce once-per-second reports of fuel efficiency over the last minute in kilometers per liter). Let us suppose that, in the first iteration of the outer loop for invocation 601, step 311 sets TP to template 502 and removes that template from T.

Thus, in invocation 601, N is again 1. Step 322 of invocation 601 sets RK to the requirement for input 0 of template 502, namely once-per-second reports of fuel efficiency over the last minute in miles per gallon. Since RK is in PR, steps 324 and 325 are not executed on this iteration of the first inner loop of invocation 601, and A[0] remains empty. The comparison with the set PR in step 323 prevents circular synthesis of data sources, such as trying to synthesize a miles-per-gallon source from a kilometers-per-liter source and trying to synthesize that kilometers-per-liter source, in turn, from a miles-per-gallon source. If circular synthesis were attempted, it would result in infinite recursion. In a given invocation of the recursive search, the set PR contains the values of R for all the other currently active invocations.

K is then increased to 1 and the first inner loop of invocation 601 terminates. Since A[0] is empty, step 330 sets CP to an empty set, so the body of the second inner loop is never executed. On the second iteration of the outer loop, step 311 sets TP to template 503 and removes it from T. Since template 503 has two inputs, step 312 sets N to 2 and step 313 allocates an array with elements A[0] and A[1]. On the first iteration of the first inner loop, with K=0, RK is set to the requirement for input 0 of template 503, for once-per-second reports of kilometers traveled over the last minute. Since this requirement is not in PR, step 324 of invocation 601 activates invocation 602, with R equal to once-per-second reports of kilometers traveled over the last minute and PR equal to the set {once-per-second reports of fuel efficiency over the last minute in miles per gallon, once-per-second reports of fuel efficiency over the last minute in kilometers per liter}.

Step 300 of invocation 602 sets S to the empty set and step 301 sets T to the set consisting of template 504 (the only template in the template repository whose output is once-per-second reports of kilometers traveled in the last minute). Step 311 sets TP to template 504, removing it from T, step 312 sets N to 1, and step 313 allocates a one-element array. The first inner loop is executed with K=0, and RK is set to the requirement for input 0 of template 504, for once-per-second reports of the odometer reading in kilometers. Since RK is not in PR, step 324 in invocation 602 activates invocation 603, with R equal to once-per-second reports of the odometer reading in kilometers and PR equal to the set {once-per-second reports of fuel efficiency over the last minute in miles per gallon, once-per-second reports of fuel efficiency over the last minute in kilometers per liter, once-per-second reports of kilometers traveled over the last minute}.

Step 300 of invocation 603 sets S to the empty set and step 301 sets T to the set consisting of template 505 (the only template in the template repository whose output is once-per-second odometer readings in kilometers). Step 311 sets TP to template 505, removing it from T, step 312 sets N to 1, and step 313 allocates a one-element array. The first inner loop is executed with K=0, and RK is set to the requirement for input 0 of template 505, for once-per-second vehicle telemetry vectors. Since RK is not in PR, step 324 in invocation 603 activates invocation 604, with R equal to once-per-second vehicle telemetry vectors and PR equal to the set {once-per-second reports of fuel efficiency over the last minute in miles per gallon, once-per-second reports of fuel efficiency over the last minute in kilometers per liter, once-per-second reports of kilometers traveled over the last minute, once-per-second reports of the odometer reading in kilometers }.

Step 300 of invocation 604 sets S to the set consisting of the one data source in the data-source-descriptor repository, the vehicle telemetry unit, since this data source provides once-per-second vehicle telemetry vectors. In contrast, there are no templates in the template repository producing such output, so step 301 sets T to the empty set. Invocation 604 returns immediately with a set containing only data source 701 of FIG. 7A, the vehicle telemetry unit.

Back in invocation 603, the set consisting of data source 701 is assigned to A[0]. Since N=1 in invocation 603, the first inner loop terminates. Step 330 sets CP to the set {<data source 701>}. In the second inner loop, step 341 removes the 1-tuple <data source 701>from this set and step 342 instantiates TP, template 505, using data source 701 as its input. The resulting data source 702 is added to S (which was previously empty). Since CP is now empty the second inner loop terminates, and since T is now empty in invocation 603, the outer loop now terminates. Invocation 603 returns a set containing only data source 702.

Back in invocation 602, the set consisting of data source 702 is assigned to A[0]. Since N=1 in invocation 602, the first inner loop terminates. In the second inner loop, step 341 removes the 1-tuple <data source 702>from this set and step 342 instantiates TP, template 504, using data source 702 as its input. Invocation 602 returns a set containing only the resulting data source 703.

Back in invocation 601, in the second iteration of the outer loop, and the first iteration of the first inner loop, N=2 and K=0, and step 325 assigns the set consisting of data source 703 to A[0]. The first inner loop is now repeated with K=1, and RK is set to the requirement for input 1 of template 503, once-per-second reports of liters of fuel consumed over the last minute. Since this requirement is not in PR (the set {once-per-second reports of fuel efficiency over the last minute in miles per gallon}), step 324 of invocation 601 activates invocation 605, with R equal to once-per-second reports of liters of fuel consumed over the last minute and PR equal to the set {once-per-second reports of fuel efficiency over the last minute in miles per gallon, once-per-second reports of fuel efficiency over the last minute in kilometers per liter}.

Invocation 605 works in a manner analogous to invocation 602, spawning an invocation 606 that works in a manner analogous to invocation 603, spawning an invocation 607 that works in a manner analogous to invocation 604. Invocation 607 returns a set consisting of the data source 704, which, like data source 701, is the vehicle telemetry unit. Invocation 606 uses this result to synthesize data source 705 for once-per-second reports of fuel level in liters, and returns a set consisting of data source 705. Invocation 605 uses this result to synthesize data source 706 for once-per-second reports of liters of fuel consumed in the past minute, and returns a set consisting of data source 706.

Back once again in invocation 601, in the second iteration of the outer loop and the second iteration of the first inner loop, N=2 and K=1, and step 325 assigns the set consisting of data source 706 to A[1]. Step 326 increments K to 2 and the first inner loop terminates. Since A[0] is the set {data source 703} and A[1] is the set {data source 706}, step 330 sets CP to the Cartesian product {<data source 703, data source 706>}. Step 341 removes the 2-tuple from CP and step 342 instantiates TP, template 503, using data source 703 for input 0 and data source 706 for input 1. The resulting data source 707 is added to S (which was previously empty). Since CP is now empty the second inner loop terminates, and since T is now empty in invocation 601, the outer loop now terminates. Invocation 601 returns a set consisting of data source 707.

Back in invocation 600, in the first iteration of the outer loop and the first iteration of the first inner loop, N=1 and K=0, and step 325 assigns the set consisting of data source 707 to A[0]. Step 326 sets K to 1 and the first inner loop terminates. Step 330 sets CP to {<data source 707>}, step 341 removes the 1-tuple <data source 707>from CP, and step 342 instantiates TP, template 501, using data source 707 for input 0. The resulting data source 708 is added to S (which was previously empty). Since CP is now empty the second inner loop terminates. The second iteration of the outer loop begins, and step 311 sets TP to template 511. Since template 511 has two inputs, step 312 sets N to 2 and step 313 allocates an array with elements A[0] and A[1]. On the iteration of the first inner loop with K=0, RK is set to the requirement for input 0 of template 511, once-per-second reports of miles traveled over the last minute. Since RK is not in PR (the empty set), step 324 in invocation 600 activates invocation 611, with R equal to once-per-second reports of miles traveled over the last minute and PR equal to the set {once-per-second reports of fuel efficiency over the last minute in miles per gallon}.

Step 300 of invocation 611 sets S to the empty set and step 301 sets T to the set consisting of template 512 (the only template in the template repository whose output is once-per-second reports of miles traveled over the last minute). Step 311 sets TP to template 512, removing it from T, step 312 sets N to 1, and step 313 allocates a one-element array. The first inner loop is executed with K 0, and RK is set to the requirement for input 0 of template 512, for once-per-second reports of kilometers traveled over the last minute. Since RK is not in PR, step 324 in invocation 611 activates invocation 612, with R equal to once-per-second reports of kilometers traveled over the last minute and PR equal to the set {once-per-second reports of fuel efficiency over the last minute in miles per gallon, once-per-second reports of miles traveled over the last minute}.

Invocation 612 behaves in essentially the same way as invocation 602 (in which R is also equal to once-per-second reports of kilometers traveled over the last minute, spawning an invocation 613 that behaves in essentially the same way as invocation 603, spawning an invocation 614 that behaves in essentially the same way as invocation 604. Invocation 614 returns a set consisting of the data source 711, which is the vehicle telemetry unit. Invocation 613 uses this result to synthesize data source 712 for once-per-second reports of odometer readings in kilometers, and returns a set consisting of data source 712. Invocation 612 uses this result to synthesize data source 713 for once-per-second reports of kilometers traveled in the past minute, and returns a set consisting of data source 713.

Back in invocation 611, the set consisting of data source 713 is assigned to A[0]. Since N=1 in invocation 611, the first inner loop terminates. Step 330 sets CP to the set {<data source 713>}. In the second inner loop, step 341 removes the 1-tuple <data source 713>from this set and step 342 instantiates TP, template 504, using data source 713 as its input. The resulting data source 714 is added to S (which was previously empty). Since CP is now empty the second inner loop terminates, and since T is now empty in invocation 611, the outer loop now terminates. Invocation 611 returns a set consisting of data source 714.

Back in invocation 600, in the second iteration of the outer loop and the first iteration of the first inner loop, N=2 and K=0, and step 325 assigns the set consisting of data source 714 to A[0]. The first inner loop is now repeated with K=1, and RK is set to the requirement for input 1 of template 511, once-per-second reports of gallons of fuel consumed over the last minute. Since this requirement is not in PR (the empty set), step 324 of invocation 600 activates invocation 621, with R equal to once-per-second reports of gallons of fuel consumed over the last minute and PR equal to the set {once-per-second reports of fuel efficiency over the last minute in miles per gallon}.

Step 300 of invocation 621 sets S to the empty set and step 301 sets T to the set consisting of template 513 (the only template in the template repository whose output is once-per-second reports of gallons of fuel consumed over the last minute). Step 311 sets TP to template 513, removing it from T, step 312 sets N to 1, and step 313 allocates a one-element array. The first inner loop is executed with K=0, and RK is set to the requirement for input 0 of template 513, for once-per-second reports of liters of fuel consumed over the last minute. Since RK is not in PR, step 324 in invocation 621 activates invocation 622, with R equal to once-per-second reports of liters of fuel consumed over the last minute and PR equal to the set {once-per-second reports of fuel efficiency over the last minute in miles per gallon, once-per-second reports of gallons of fuel consumed over the last minute}.

Invocation 622 behaves in essentially the same way as invocation 605 (in which R is also equal to once-per-second reports of liters of fuel consumed over the last minute), spawning an invocation 623 that behaves in essentially the same way as invocation 606, spawning an invocation 624 that behaves in essentially the same way as invocation 607. Invocation 624 returns a set consisting of the data source 715, which is the vehicle telemetry unit. Invocation 623 uses this result to synthesize data source 716 for once-per-second reports of fuel-level readings in liters, and returns a set consisting of data source 716. Invocation 622 uses this result to synthesize data source 717 for once-per-second reports of liters of fuel consumed in the past minute, and returns a set consisting of data source 717.

Back in invocation 621, the set consisting of data source 717 is assigned to A[0]. Since N=1 in invocation 621, the first inner loop terminates. Step 330 sets CP to the set {<data source 717>}. In the second inner loop, step 341 removes the 1-tuple <data source 717>from this set and step 342 instantiates TP, template 513, using data source 717 as its input. The resulting data source 718 is added to S (which was previously empty). Since CP is now empty the second inner loop terminates, and since T is now empty in invocation 621, the outer loop now terminates. Invocation 621 returns a set consisting of data source 718.

Back in invocation 600, in the second iteration of the outer loop and the second iteration of the first inner loop, N=2 and K=1, and step 325 assigns the set consisting of data source 718 to A[1]. Step 326 increments K to 2 and the first inner loop terminates. Since A[0] is the set {data source 714} and A[1] is the set {data source 718}, step 330 sets CP to the Cartesian product {<data source 714, data source 718>}. Step 341 removes the 2-tuple from CP and step 342 instantiates TP, template 511, using data source 714 for input 0 and data source 718 for input 1. The resulting data source 719 is added to S (which previously contained data source 708). Since CP is now empty the second inner loop terminates, and since T is now empty in invocation 600, the outer loop now terminates. Invocation 601 returns a set consisting of data sources 708 and 719.

Data source 719 is the data source depicted in FIG. 2. The data source is depicted in FIG. 2 as a directed acyclic graph, with a single auto-telemetry-unit node 207 used by two synthesizers, and in FIG. 7B as a tree, with two distinct occurrences 711 and 715 of the auto-telemetry-unit node. The process of FIGS. 3A-3C is easily modified to generate directed acyclic graphs instead of trees, by maintaining a set of already constructed data sources. Each time a data source is discovered in step 300 or synthesized in step 342, a check is made to see whether the data source is already in the set. If so, the data source in the set is reused; if not, the newly discovered or synthesized data source is used, and is added to the set so that it may be reused later.

A requirement for a data source may involve several attributes of that data source. For example, the requirement “once-per-second reports of liters of fuel consumed over the last minute” involves the phenomenon being measured (amount of fuel consumed over the last minute), units of measurement (liters), and the frequency with which new values appear in the input stream. The translation from once-per-second reports of liters of fuel consumed over the last minute to once-per-second reports of gallons of fuel consumed over the last minute entails multiplication by 0.26417; this is the same process by which any data-source whose the unit of measurement is liters can be translated to one meet the requirements that are the same except that the unit of measurement is gallons (for example, to translate the number of liters of water used to irrigate crops over the past week to the number of gallons of water used to irrigate crops over the past week). Similarly, the aggregation of once-per-second odometer readings to compute the distance traveled over the past minute uses the same mechanism (for example, maintaining a queue of the 60 most recent readings and emitting the difference between the newly received reading and the 60-second-old reading each time a new reading is received) as the aggregation of once-per-second fuel-level readings to compute the amount of fuel consumed over the last minute.

Rather than populate a synthesizer-template repository with separate templates for each of the many possible combinations of data-source attributes, it is possible to populate the repository with metatemplates, in effect, templates for templates, that provide synthesis mechanisms based on individual attributes, such as unit of measure, or the number of readings to be queued to generate differences. Upon receiving a request for all templates whose outputs satisfy a given requirement, the synchronizer-template repository can then instantiate the applicable metatemplates to obtain suitable templates.

The foregoing description of the invention has been presented for purposes of illustration and description. It is not intended to be exhaustive or to limit the invention to the precise form disclosed, and other modifications and variations may be possible in light of the above teachings. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for obtaining data sources satisfying a result requirement in a network environment that includes external data sources and synthesizer templates, each external data source having an output contract and each synthesizer template corresponding to a synthesis method capable of producing an output value from input values, synthesizer-input requirements to be satisfied by inputs, and a synthesizer-output contract satisfied by each resulting output, the method comprising:
selecting a synthesizer template to be instantiated;
selecting for each input of the synthesizer template at least one data source from an external or synthesized data source whose output contract satisfies the synthesizer-input requirement for the input of the synthesizer template;
instantiating the synthesizer template using the data source selected for the input of the synthesizer template, thereby obtaining a new synthesized data source that may be selected in subsequent performances of the selecting the data source; and
constructing a set consisting of at least one resulting synthesized data source or external data source whose output contract satisfies the result requirement.

2. The method of claim 1, wherein the network environment includes a store of metatemplates concerned with a subset of attributes of data sources, and selecting the synthesizer template to be instantiated includes instantiating metatemplates to form the synthesizer template.

3. The method of claim 1, further comprising:
identifying a collection of templates whose outputs satisfy the result requirement; and
for each template in the collection of templates:
identifying a set of external and synthesized data sources that satisfy each input requirement of the template;
forming a set of instances of the template, each instance using as its inputs the data sources in a distinct element of a Cartesian product of the set of external and synthesized data sources that satisfy each input requirement of the template for each input of the template; and
forming a union of the set of instances of the template formed for each template, and the set of external data sources with descriptors that directly satisfy the result requirement.

4. The method of claim 3, wherein the network environment includes a store of metatemplates concerned with a subset of attributes of data sources, and selecting the synthesizer template to be instantiated includes instantiating metatemplates to form the synthesizer template.

5. A system for obtaining data sources satisfying a result requirement in a network environment that includes external data sources and synthesizer templates, each external data source having an output contract and each synthesizer template corresponding to a synthesis method capable of producing an output value from input values, synthesizer-input requirements to be satisfied by inputs, and a synthesizer-output contract satisfied by each resulting output, the method comprising:
a first selecting module configured to select a synthesizer template to be instantiated;
a second selecting module configured to select for each input of the synthesizer template at least one data source from an external or synthesized data source whose output contract satisfies the synthesizer-input requirement for the input of the synthesizer template;
an instantiating module configured to instantiate the synthesizer template using the data source selected for the input of the synthesizer template, thereby obtaining a new synthesized data source that may be selected subsequently by the second selecting module; and
a constructing module configured to construct a set consisting of at least one resulting synthesized data source or external data source whose output contract satisfies the result requirement.

6. The system of claim 5, wherein the network environment includes a store of metatemplates concerned with a subset of attributes of data sources, and the first selecting module is configured to instantiate metatemplates to form the synthesizer template.

7. A computer program product embodied in a tangible media comprising:
computer readable program codes coupled to the tangible media for obtaining data sources satisfying a result requirement in a network environment that includes external data sources and synthesizer templates, each external data source having an output contract and each synthesizer template corresponding to a synthesis method capable of producing an output value from input values, synthesizer-input requirements to be satisfied by inputs, and a synthesizer-output contract satisfied by each resulting output, the computer readable program codes configured to cause the program to:
select a synthesizer template to be instantiated;
select for each input of the synthesizer template at least one data source from an external or synthesized data source whose output contract satisfies the synthesizer-input requirement for the input of the synthesizer template;
instantiate the synthesizer template using the data source selected for the input of the synthesizer template, thereby obtaining a new synthesized data source that may be selected in subsequent performances of the selecting the data source; and
construct a set consisting of at least one resulting synthesized data source or external data source whose output contract satisfies the result requirement.

8. The computer program product of claim 7, wherein the network environment includes a store of metatemplates concerned with a subset of attributes of data sources, and the program code to select the synthesizer template to be instantiated includes program code to instantiate metatemplates to form the synthesizer template.

9. The computer program product of claim 7, further comprising program codes configured to cause the program to:
identify a collection of templates whose outputs satisfy the result requirement; and
for each template in the collection of templates:
identify a set of external and synthesized data sources that satisfy each input requirement of the template;
form a set of instances of the template, each instance using as its inputs the data sources in a distinct element of a Cartesian product of the set of external and synthesized data sources that satisfy each input requirement of the template for each input of the template; and
form a union of the set of instances of the template formed for each template, and the set of external data sources with descriptors that directly satisfy the result requirement.

10. The computer program product of claim 9, wherein the network environment includes a store of metatemplates concerned with a subset of attributes of data sources, and the program code to select the synthesizer template to be instantiated includes program code to instantiate metatemplates to form the synthesizer template.
